(19) United States
(12) Patent Application Publication
(10) Pub. No.: US 2016/0207394 A1
(43) Pub. Date: Jul. 21, 2016

(54) VENTILATION SHUT-OFF FLAP FOR AUTOMOBILE

(71) Applicant: VALEO SYSTEMS THERMIQUES, Le Mesnil Saint Denis (FR)

(72) Inventors: Frédéric Vacca, Behoust (FR); Christophe Thullier, Montigny-Le-Bretonneux (FR); Enzo Mitidieri, Acheres (FR)

(73) Assignee: Valeo Systemes Thermiques, Le Mesnil Saint Denis (FR)

(21) Appl. No.: 14/916,046

(22) PCT Filed: Sep. 9, 2014
(86) PCT No.: PCT/EP2014/069213

§ 371 Date: Mar. 2, 2016

(30) Foreign Application Priority Data
Sep. 9, 2013 (FR) 1358639

(51) Int. Cl. B60K 11/08

(52) U.S. Cl. CPC B60K 11/085

(57) ABSTRACT

A flap for shutting off a ventilation device for a vehicle is disclosed. The flap has at least one shut-off surface for shutting off an air flow, extending longitudinally along an axis of rotation and including, at least at one of its longitudinal ends, a journal about which the rotation of the shutter is articulated, the journal being aligned with the axis of rotation and is inserted in a bearing of a support of the flap. The flap includes, in the axial extension of the shut-off surface, a stop element offset radially, shaped to apply an axial force to a first part of the support of the shutter, and comes into rotational abutment against a second part of the shutter support. A motor vehicle ventilation device support framework having at least one cross member forming a support for at least one flap for shutting off the device is also disclosed.

The field of the present invention is that of motor vehicles and, more particularly, that of the ventilation devices for motor vehicle front faces or electric fan sets.

The vehicles are equipped with heat exchangers, notably cooling radiators or condensers, which are placed at the front of the vehicle and which are passed through by outside air to exchange heat with the fluid which runs through them. To force the circulation of this air through the exchanger or exchangers, a fan is placed upstream or downstream thereof, the upstream or downstream direction being assessed in this document with reference to the direction of flow of the air.

The inlets for the cooling air are placed at the front of the motor vehicle, at its front face, and radiator grilles are conventionally placed across them to allow the circulation of the air to the exchanger or exchangers while preventing the ingress of foreign bodies.

It is known practice to use controlled flaps on the front face in order to reduce the drag coefficient and thus improve the operation of the cooling and air conditioning. These flaps, which are generally arranged behind the radiator grilles, are arranged horizontally across the flow and can be either open and allow the maximum of air to pass, or more or less closed and then partially or entirely shut off the passage of the air.

These flaps are commonly produced in the form of a series of coplanar rectangular plates which are positioned above one another and which extend along a median rotation axis. They comprise a control lever for opening them and closing them. This lever is linked to a rod, which is itself actuated via an actuator driven by a power cylinder or an electric motor.

At each of the longitudinal ends of the flap, the axis of rotation is commonly embodied by a journal whose function is to be inserted into a cylindrical gutter which is hollowed out in a cross member of the duct guiding the air, so as to ensure their support and their freedom of rotational movement.

Hereinbelow in the document, the terms “axial”, “radial” or “tangential” relate to this axis of rotation. As is known, the gutter, oriented axially, is cylindrical over a large part of its circumference, with an opening on an angular segment to allow the corresponding journal to pass when the flap is mounted on the cross member. The length of the circumference over this segment is less than the diameter of the journal so that the latter remains within the cylinder of the gutter once it has been installed therein and that it is not released upon an impact or a bump to the vehicle. To be able to enter the journal into the gutter, the latter is, however, not entirely cylindrical, but includes two flats extending axially, positioned opposite one another, and away from one another by a length slightly less than that of the circumference of the angular segment concerned. In this way, the installation of the flap on the cross member is performed, firstly, by positioning the flats of the journal facing the open segment of the gutter then by driving the journal into the latter, and finally, by turning it by a quarter-turn to bring one of its entirely cylindrical faces to face the open segment.

This solution does however have the drawback that, in certain conditions, the flap can rotate in the reverse direction to that of assembly and itself perform a quarter-turn. There is then a risk of the journal exiting from the gutter and disrupting the correct operation of the aeration grille by interfering with the adjacent flaps.

The aim of the present invention is to propose a flap which mitigates the abovementioned drawbacks by offering a safeguard against any untimely detachment of the journal.

To this end, the subject of the invention is a shut-off flap for a ventilation device, notably for a motor vehicle, comprising at least one surface for shutting off a flow of air extending longitudinally along an axis of rotation and comprising, at at least one of its longitudinal ends, a journal for rotationally articulating said flap, said journal being aligned on said axis of rotation and intended to be inserted into a bearing of a support of said flap, said flap comprising, in the axial extension of said shut-off surface, a stop element, radially offset and formed to, on the one hand, exert an axial force on a first part of said support of the flap and, on the other hand, come into rotational abutment against a second part of said support of the flap.

Such a flap can be used to operate with stop in the open position by snap-fitting of the flap onto its support, this being done by a simple and intuitive movement. The assembly is performed by a rotation, for example by approximately 45°, which engages the snap-fitting under the action of the stop element and the impossibility of untimely detachment, by virtue of the stop position defined between said stop element and said support.

Advantageously, said stop element comprises at least one planar face extending radially from said longitudinal end of the shut-off surface, said face being intended to form said rotational stop. This configuration offers a rotational stop for the flap which makes it possible to immobilize it in a position, in particular a precise, fully open position.

Preferentially, said planar face ends at its distal end with a radially oriented edge, intended to exert said axial force. This way the axial driving-in of the support and the rotational blocking of the flap on the support, particularly in the fully open position, are performed with a same planar face.

Said flap will be able to comprise an actuation element, such as a lever, offset radially relative to said axis of rotation of the flap. Said actuation element and said stop element are advantageously distinct from one another, notably by being angularly separated and/or at two opposite axial ends of the flap.

Said flap will be able to comprise a lateral flank, substantially at right angles to said shut-off surface, notably made of the same material as said shut-off surface. Advantageously, said journal, said stop element and/or said actuation element extend axially from said lateral flank, notably by being made of the same material as said lateral flank.

The invention relates also to a support frame for a ventilation device for a motor vehicle comprising at least one cross member forming a support for at least one shut-off flap of said device by a rotation of said flap about its axis of rotation, said cross member comprising at least one cut-out forming a bearing for a journal of said flap. Said cross member also comprises at least one elastic element configured to be retracted by axial driving-in under the effect of a rotation of the flap about its axis and to offer a rotational stop for the flap.

The presence of a retractable elastic element allows for the definition of a stop in the open position of the flaps, according to a simple and intuitive snap-fitting movement.

Preferentially, said elastic element is a rounded tongue, notably circular, extending angularly, notably circularly, about said cut-out, from a radial side attached to said cross member, the other three sides being free to move axially. Said cut-out will in particular be able to be coaxial with said bearing. The circular form offers the advantage of a simple cooperation with the flap.

Advantageously, said tongue is planar and bears, at its end opposite the side attached to said cross member, an axial extension forming a bearing point for its retraction upon the rotation of said flap.

Preferentially, said extension has the form of a face in the form of a portion of cylinder, coaxial with said bearing, said face extending axially and ending with an edge forming a ramp progressively moving away from the planar surface of the tongue.

In a particular embodiment, said extension has the form of a dihedron, comprising in addition to said cylindrical face a planar face oriented radially and positioned at the end of said ramp, said planar face being intended to form a stop limiting the rotation of said flap.

In another particular embodiment, the cut-out comprises an open angular segment making it possible to introduce a journal of the flap, said angular segment comprising two parallel flats configured to extend along the axis of said journal.

The invention relates also to a ventilation device for a motor vehicle comprising at least one frame and at least one flap as described above, the stop element of said flap being positioned in such a way as to cooperate with said elastic element upon a rotation of the flap, in particular after the introduction of its journal into said open segment.

Advantageously, the angular offset between the planar face of the flap and the flats of the journal, extending axially along the axis of articulation of the flap, is then equal to the angular offset between the orientation of said angular segment and the low point of said ramp.

Preferentially, the extension of the ramp is such that the opening of the angular segment is located facing the flats of the journal when the distal edge of the planar face of the flap is positioned at the high point of said ramp.

That being the case, according to another aspect of the invention, the retractable element will be able to be located on the flap with the stop element on its support cross member.

The invention thus relates, more generally, to a ventilation device for a motor vehicle comprising a support frame and at least one shut-off flap, said flap comprising at least one surface for shutting off a flow of air, extending longitudinally along an axis of rotation, and comprising, at at least one of its longitudinal ends, a journal for rotationally articulating said flap on said support frame, said journal being aligned on said axis of rotation and intended to be inserted into a bearing of said support frame, said support frame being provided with at least one cross member forming a support for said shut-off flap or flaps, said cross member having at least one cut-out forming said bearing of the journal of said flap or flaps, said device comprising a stop element offset radially and formed to, on the one hand, exert an axial force on a retractable elastic element of said device by axial driving-in under the effect of a rotation of the flap about its axis when the flap is positioned on the support frame and, on the other hand, come into rotational abutment against a part of said retractable elastic element to limit the rotation of the flap about its axis of rotation.

The invention also relates to a front face of a motor vehicle comprising a ventilation device as described above.

The invention relates also to an electric fan set of a motor vehicle comprising a ventilation device as described above, positioned upstream or downstream of a heat exchanger of said set.

The invention will be better understood, and other aims, details, features and advantages thereof will become more clearly apparent from the following detailed explanatory description of an embodiment of the invention given as a purely illustrative and nonlimiting example, with reference to the attached schematic drawings.

In these drawings:

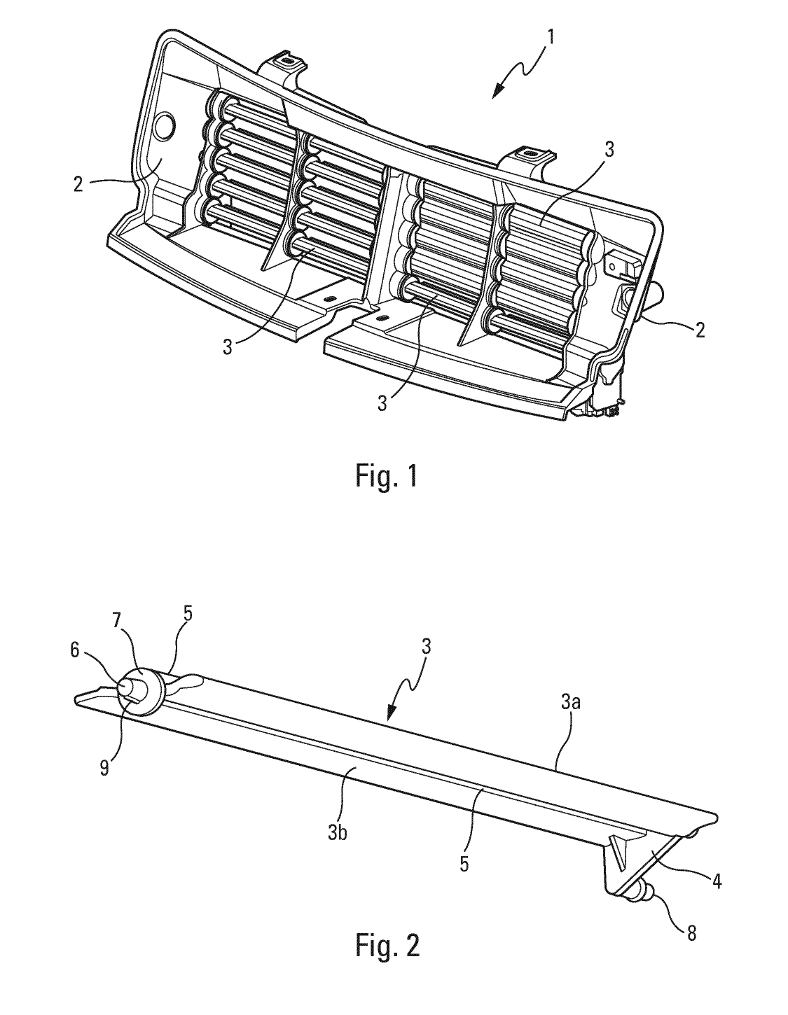

FIG. 1 is a perspective view of an exemplary ventilation device according to the invention;

FIG. 2 is a perspective view, from below, of a shut-off flap of the device of FIG. 1;

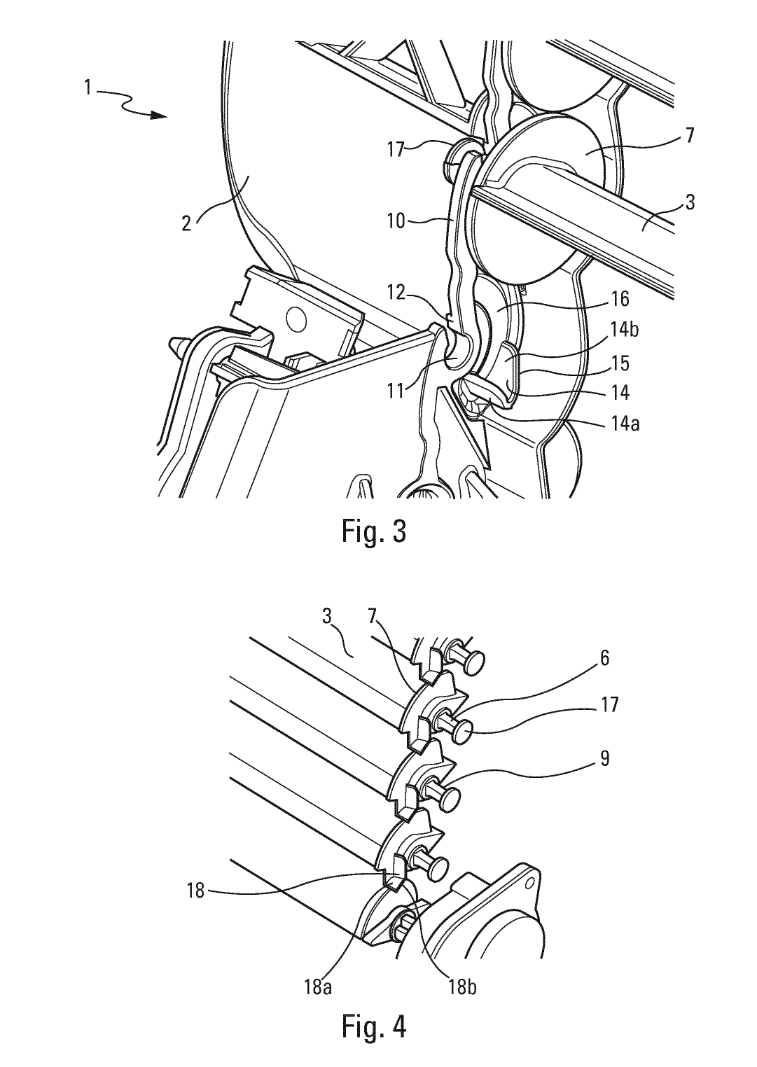

FIG. 3 is a perspective view of a cross member of a ventilation device according to the invention, one of its flaps not having been illustrated in order to better reveal a part of the cross member intended to cooperate with said flap;

FIG. 4 is a perspective view of the end of shut-off flaps according to the invention;

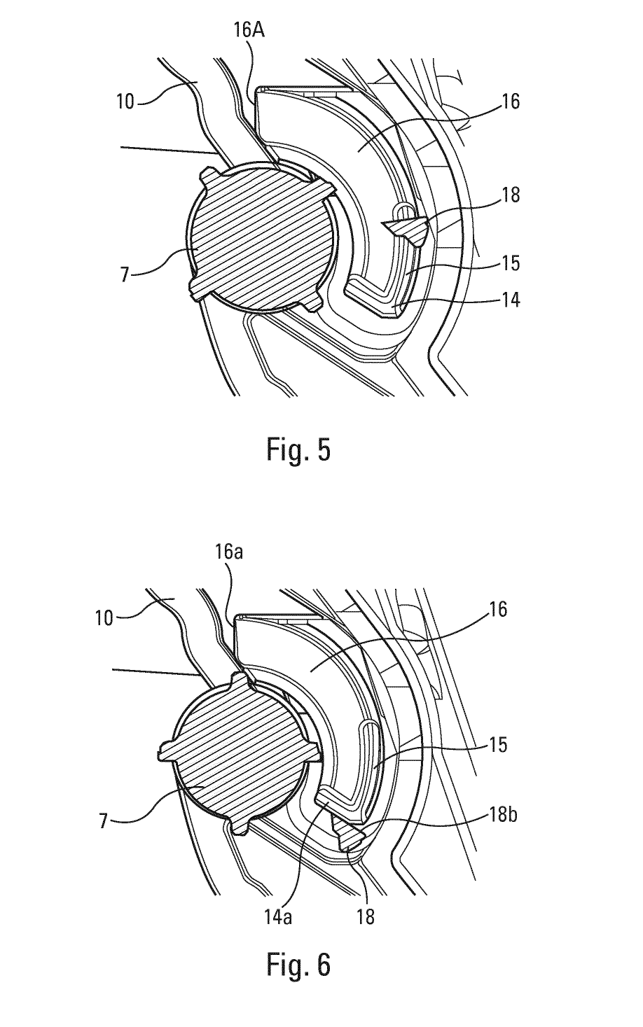

FIG. 5 is a detailed view, in section, of a flap of FIG. 4, upon its installation on a cross member of FIG. 3;

FIG. 6 is a detail view, in section, of a flap of FIG. 4, in the fully open position; and

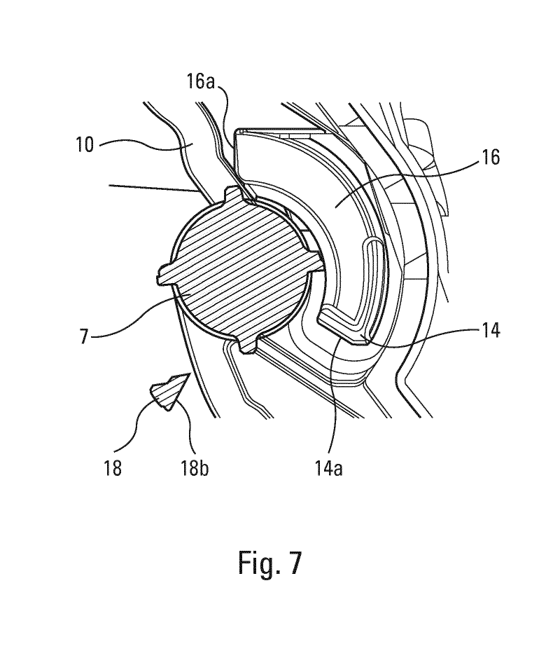

FIG. 7 is a detail view, in section, of a flap of FIG. 4, in place on a cross member of FIG. 3, in the fully closed position.

Referring to FIG. 1, a ventilation device according to the invention can be seen, here intended to be situated at the front face of a motor vehicle. It forms, for example, a duct 1 for guiding the air which penetrates into the front compartment of a motor vehicle and which is intended to be oriented toward a heat exchanger such as a condenser or a radiator, not represented. Said ventilation device comprises a support frame 2, of substantially parallelepipedal form, which is intended to meet, upstream, a radiator grille, also not represented, intended to prevent any ingress of foreign bodies while forming a style element. Said frame bears, on the downstream side, a series of flaps 3 which are positioned parallel and in cascade fashion one on top of the other. Said flaps 3 are rotationally mobile, each about a horizontal axis. Said flaps 3 are arranged relative to one another in such a way that, in the open position, they offer the largest possible passage for the air and, in the closed position, they meet and completely shut off the air stream. Said flaps 3 are rotationally articulated on cross members of the support frame 2. Said cross members extend vertically and in the direction of circulation of the air, that is to say in a direction transversal to the axis of rotation of the flaps.

FIG. 2 shows, in perspective, a flap 3. The flap proper, that is to say the part which guides or which shuts off the flow of air, has the form of a plate or shut-off surface comprising an upstream part 3a and a downstream part 3b (referring to the direction of circulation of the air when they are in the open position), which are separated by a rib 5 positioned substantially at the level of the axis of rotation of the flap. The two upstream and downstream parts extend longitudinally in the direction of the axis of rotation and transversely on a same radial plane relative to this axis, with, here, undulations relative to this plane which tend to reduce their aerodynamic impact.

At its two longitudinal ends, the flap 3 comprises means for rotating it. These means comprise two journals 6 aligned with the axis of rotation and extending longitudinally at each of the ends, beyond the flap proper. These journals 6 have a cylindrical form and comprise two flats 9 which are opposite one another extending axially in a plane parallel to the axis of rotation. Lateral flanks 4, 7 extend radially between these journals and the plate so as to form a barrier with respect to the duct 1, notably by cooperating with the cross members of the frame. At one of the ends, there is also an actuation element for rotating the flap. Said actuation element is offset radially relative to the axis of rotation of the flap. It will be able to be an axial extension 8 onto which is intended to be fixed a control rod (not represented) which, by a longitudinal movement, creates a rotation of the plate and, thereby, generates the rotation of all of the flap 3. Said actuation element is here made of the same material as one 4 of said lateral flanks.

FIG. 3 shows the attachment of the flaps 3 onto one of the cross members of the support frame 2. Said cross member has, over its length, cut-outs 11, which form plane bearings for axes of rotation of the flaps and in which the journals 6 of these flaps are fitted. The cut-outs 11 are repeated over the length of the cross member as a function of the number of flaps 3 to be supported.

The plane bearings 11 emerge on either side of the thickness of the cross member to offer a maximum seat for the journal of the flap and they are open over an angular segment 12 which emerges from the section of the cross member to allow the introduction of the journal 6 when the flap 3 is mounted. The opening of this segment 12 is such that it is less than the diameter of the journal 6 over the entirely cylindrical part of the journal but that it is greater than the thickness of said journal between its two flats 9. It is thus possible to mount the flap on the cross member by aligning the flats 9 with the lateral walls of the segment 12 then, after having introduced the journal, to ensure that the flap is held in the plane bearing along its travel between the open and closed positions.

The cross member 10 also comprises, on the side of each plane bearing 11, a retractable elastic element 13. The latter here has the form of a circular tongue, centered on the plane bearing 11 and therefore on the axis of rotation about which the flap 3 will rotate in its quarter-turn of assembly. This tongue is free on three of its sides and is attached to the cross member 10, with which it is coplanar at rest, only by its fourth side 16a which is oriented radially. It is therefore retractable by a driving-in with respect to the plane of the cross member 10, if a force oriented in the direction of the axis of rotation of the flap 3 is exerted thereon.

At its free end opposite the side 16a attached to the cross member, the retractable tongue 16 bears a dihedron 14 which extends at right angles to the plane of the tongue 16 and of the cross member 10, on the side of the flap to be mounted. This dihedron comprises two faces: a face of square or rectangular form, called stop face 14a, which is oriented radially relative to the axis of rotation of the corresponding flap 3, and a face, called ramp face 14b, which extends at right angles to the preceding one and which has the form of a portion of cylinder whose generatrices are parallel to the axis of rotation. This ramp face 14b has, seen from the front, the form of a right-angled triangle, of which a first side from the right is placed on the tongue 16, a second extends at right angles to this tongue and of which the hypotenuse forms a ramp 15 which rises progressively to reach the height of the stop face 14a when it rejoins it at the joining line of the two faces of the dihedron.

FIG. 4 shows a succession of flaps 3, according to the invention, the longitudinal end of which comprises a stop element which is intended to cooperate with the retractable tongue 16 to ensure a secure snap-fitting of the flap with the cross member 10, at the level of the corresponding plane bearing 11. For reasons of legibility of the figure, the lateral flanks 7 are represented only partially. As in the flap of FIG. 2, the journal 6 is extended axially beyond this lateral flank, notably as a continuity of material, with two flats 9 situated on either side of its axis.

The flap can moreover comprise, at the outer longitudinal end of the journal 6, a radial disk 17 whose diameter is greater than that of the plane bearing into which the journal passes. It thus forms a shoulder for retaining the flap in its housing, and it makes it possible to retain it even if the overall length thereof decreases because of a longitudinal flexing provoked, for example, by an aerodynamic fluttering or else by a vibratory phenomenon.

According to the invention, the flap comprises a stop element such as a stop-forming protuberance 18 which is intended to cooperate with the dihedron 14 borne by the retractable tongue 16 when the flap 3 is mounted, as will be explained below. The stop is represented in FIG. 4 in the form of a trihedron, without this form being essential, with a planar face 18a oriented radially and which extends axially from the lateral flank 7 of the flap, notably as a continuity of material. The object of this planar face 18a of the flap is to serve as a mirror face for the stop face 14a of the dihedron 14; even though, in the figures, the end of the flap and the cross member concerned do not correspond.

The planar face 18a of the flap is offset radially relative to the axis of the journal 6, at a distance such that it is located positioned on the same circle as the ramp face 14b of the dihedron 14 borne by the retractable tongue 16. It extends radially slightly beyond the latter and ends with a radial edge 18b which ensures the contact between the stop 18 and the ramp 15 of the dihedron borne by the retractable tongue 16. In this way, when the flap rotates for it to be mounted, there is interference between this stop 18 of the flap and the ramp 15 of the dihedron and the rotation results in the driving-in of the retractable tongue behind its plane of rest. Circularly, the stop is located in a position such that, when the flats 9 of the journal are aligned with the open segment 12 of the plane bearing 11, it can cooperate with the ramp face 14b, at a low point of the ramp 15 and, after rotation of the flap 3 and of its journal 6, it has gone past the stop face 14a of this dihedron 14. The precise form of this stop 18, represented here as a trihedron, is unimportant provided that it can cooperate with the ramp 15 of the dihedron over a rotation of approximately 45° of the journal 6, or at the very least a rotation such that the open segment 12 is ultimately facing the flats 9 of the journal. The journal of the flap 3 is then blocked in the cut-out 11, from which it cannot exit without a reverse rotation, which is blocked by the snap-fitting.

FIGS. 5 to 7 show successive positions of the end of a flap 3 when it is mounted on a cross member 10 comprising a retractable tongue 16 according to the invention. In these figures, the longitudinal end of a flap can be seen in cross section with its lateral flank 7 and a part of the stop 18 which is linked to it. The physical link between the stop 18 and the sealing disk is not however represented. Finally, only the starts of the longitudinal plates of the flap 3 are illustrated, to avoid pointlessly overloading the figures.

In FIG. 5, the flap 3 is in its initial mounting position. The flats 9 are aligned with the lateral walls of the open segment 12, which makes it possible, by a simple press on the flap, to pass the journal 6 into the plane bearing 11. It will be noted that the stop 18 is, because of its angular positioning relative to that of the flats 9, at a low point of the ramp 15. The driving of the journal 6 into the plane bearing 11 brings this stop 18 into contact with the ramp 15 of the dihedron 14 and can even cause a backward movement of the retractable tongue 16 to be initiated.

The rotation of the flap 3, after installation on its journal 6 in the plane bearing 11, makes it possible, firstly, to circularly move the flats away from the open segment 12 and therefore prevent an untimely withdrawal of the journal, which secures the supporting of the flap 3 and, secondly, to push back the retractable tongue 16 by virtue of the increasingly strong pressure exerted by the stop 18 when the latter rises on the ramp 15.

FIG. 6 shows the respective position of the flap 3 and of the cross member 10 after a rotation such that the stop 18 has already traveled the entire length of the ramp 15 and has even gone slightly beyond it. The flap 3 is then located in a fully open position for the passage of the air through the duct 1. In this position in which the stop has gone past the stop face 14a of the retractable tongue the latter can return, under the action of the flexibility imposed by its elastic deformation around its fixed side 16a, to its position of rest, that is to say in the same plane as the face of the cross member 10 which is situated on the side of the flap 3. The stop face 14a is then positioned against the planar face 18a of the stop 18 which it mirrors.

FIG. 7 finally shows the respective position of the flap 3 and of the cross member 10 at the end of the rotation of the flap, which corresponds to the fully closed position for the passage of the air through the duct 1. The stop 18 has rotated by an angle equal to that of the flap without encountering any interference, its travel being left free from its position in FIG. 6.

From the end of the rotation which has resulted in this position and is illustrated by FIG. 6, the flap is in operational position, that is to say that its journal is held securely in the plane bearing 11, the flats thereof no longer being able to be aligned with the lateral walls of the open segment 12, by a reversal of the flap 3. The flap can then be rotationally driven between an open position (corresponding to FIG. 6) in which its stop 18 bears against the dihedron 14 and a closed position (corresponding to FIG. 7) in which the longitudinal faces of the flap bear against those of the adjacent flap or flaps.

1. A shut-off flap for a ventilation device for a motor vehicle, comprising:
at least one surface for shutting off a flow of air, extending longitudinally along an axis of rotation and comprising, at at least one of its longitudinal ends, a journal for rotationally articulating said flap, said journal being aligned on said axis of rotation and intended to be inserted into a bearing of a support of said flap; and
in the axial extension of said shut-off surface, a stop element radially offset and formed to exert an axial force on a first part of said support of the flap and come into rotational abutment against a second part of said support of the flap.

2. The flap as claimed in claim 1, in which said stop element comprises at least one planar face extending radially from said longitudinal end of the shut-off surface, said face forming said rotational stop.

3. The flap as claimed in claim 2, in which said face ends at its distal end with a radially oriented edge intended to exert said axial force.

4. A support frame for a ventilation device for a motor vehicle comprising:
at least one cross member forming a support for at least one shut-off flap of said device by a rotation of said flap about an axis of rotation,
said cross member comprising at least one cut-out forming a bearing for a journal of said flap, and a frame in which said cross member comprises at least one elastic element configured to be retracted by axial driving-in under the effect of a rotation of the flap about the axis of rotation and to offer a rotational stop for the flap.

5. The frame as claimed in claim 4, in which said elastic element is a rounded tongue extending angularly about said cut-out from a radial side attached to said cross member, the other three sides being free to move axially.

6. The frame as claimed in claim 5, in which said tongue is planar and bears, at an end opposite the side attached to said cross member, an axial extension forming a bearing point for retraction upon the rotation of said flap.

7. The frame as claimed in claim 6, in which said extension has the form of a face in the form of a portion of cylinder coaxial with said bearing, said face extending axially and ending with an edge forming a ramp progressively moving away from the planar surface of the tongue.

8. The frame as claimed in claim 7, in which said extension has the form of a dihedron, comprising in addition to said cylindrical face a planar face oriented radially and positioned at the end of said ramp, said planar face being intended to form a stop limiting the rotation of said flap.

9. The frame as claimed in claim 4, in which the cut-out comprises an open angular segment for introducing the journal of the flap, said angular segment comprising two parallel flats, configured to extend along the axis of said journal.

10. A ventilation device for a motor vehicle comprising:
at least one frame comprising at least one cross member forming a support for at least one shut-off flap of said device by a rotation of said flap about an axis of rotation, said cross member comprising at least one cut-out forming a bearing for a journal of said flap, and a frame in which said cross member comprises at least one elastic element configured to be retracted by axial driving-in under the effect of a rotation of the flap about the axis of rotation and to offer a rotational stop for the flap; and
the at least one flap as claimed in claim 1,
the stop element of said flap being positioned to cooperate with said elastic element upon a rotation of the flap.

11. The device as claimed in claim 10, wherein
said flap comprises at least one planar face extending radially from said longitudinal end of the shut-off surface,
said journal comprises two flats extending along the axis of the journal,
said elastic element of the frame bears an axial comprising a face in the form of a portion of cylinder coaxial with said bearing, said face extending axially and ending with an edge forming a ramp progressively moving away from the surface of said elastic element,
the cut-out comprises an open angular segment for introducing the journal of the flap,
the angular offset between the planar face of the flap and the flats of the journal being equal to the angular offset between the orientation of said angular segment and the low point of said ramp.

12. The device as claimed in claim 11, in which the extension of the ramp is such that the opening of the angular segment is located facing the flats of the journal when the distal edge of the planar face of the flap is positioned at the high point of said ramp.

13. A ventilation device for a motor vehicle comprising:
a support frame and at least one shut-off flap, said flap comprising at least one shut-off surface for shutting off a flow of air, extending longitudinally along an axis of rotation, and comprising, at at least one of its longitudinal ends, a journal for rotationally articulating said flap on said support frame,
said journal being aligned on said axis of rotation and intended to be inserted into a bearing of said support frame,
said support frame being provided with at least one cross member forming a support for said shut-off flap or flaps, said cross member having at least one cut-out forming said bearing of the journal of said flap or flaps, said device comprising a stop element offset radially and formed to:
exert an axial force on a retractable elastic element of said device by axial driving-in under the effect of a rotation of the flap about its axis when the flap is positioned on the support frame and,
come into rotational abutment against a part of said retractable elastic element to limit a rotation of said flap about its axis of rotation.
